(19) United States
(12) Patent Application Publication
(10) Pub. No.: US 2009/0009817 A1
(43) Pub. Date: Jan. 8, 2009

(54) SCANNING APPARATUS AND WHITE CALIBRATION METHOD THEREOF

(75) Inventors: In-ho Park, Suwon-si (KR); Kyeong-man Kim, Yongin-si (KR); Hyun-soo Oh, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/144,897

(22) Filed: Jun. 24, 2008

(30) Foreign Application Priority Data
Jul. 4, 2007 (KR) 2007-67155
Oct. 19, 2007 (KR) 2007-105737

(51) Int. Cl. H04N 1/00

(52) U.S. Cl. 358/406; 358/474

(57) ABSTRACT

A scanning apparatus includes a lookup table generating unit to generate a multidimensional lookup table to convert input signals into standard signals, a minimum value computing unit to scan a white reference and compute minimum RGB values therefrom, a calibration region determining unit to establish a minimum size region in the lookup table that contains a background (BG) point where the computed minimum RGB values coincide, and a white point of the lookup table, and a calibrating unit to calibrate data values only in the established region to white values. Optimum color representation is provided, because only the white region is established and calibrated without influencing other color regions.

### CROSS-REFERENCE TO RELATED APPLICATIONS

This application claims priority under 35 U.S.C. § 119 (a) from Korean Patent Applications Nos. 10-2007-0067155, filed on Jul. 4, 2007, and 10-2007-105737, filed on Oct. 19, 2007, in the Korean Intellectual Property Office, the disclosure of which are hereby incorporated herein in their entirety by reference.

### BACKGROUND OF THE INVENTION

1. Field of the Invention

The present general inventive concept relates to a scanning apparatus and a white calibration method thereof, and more particularly, to a scanning apparatus to subdivide a multidimensional lookup table into a plurality of multidimensional blocks, and to conduct a white calibration regarding a block region that contains a minimum input signal value and a white point, and a white calibration method thereof.

2. Description of the Related Art

A scanning apparatus scans an image from a document, graphic or film, and converts the image into digital form so that the digitized data can be displayed on a computer monitor or printed by a printer. Numerous types of image forming apparatuses, such as facsimile telecopiers, copiers or multifunction units employ such a scanning apparatus.

When a color image is scanned, it is necessary to convert the scanned input signals to standardized color signals to maintain exact and stable color in an output image, because a color image is apt to change due to factors that cause perceived color variation. The scanning apparatus thus employs a lookup table to calibrate red, green, blue (RGB) input signals into standard RGB signals.

However, using the lookup table does not prevent the color differences from all sources, particularly when the color difference is generated due to metamerism of the scanning apparatus when an image is passed through the scanning apparatus, or if a region of the scanned image that is intended to be represented in white color is erroneously expressed in color due to a foreign substance on an image sensor.

A conventional scanning apparatus conducts a white calibration by scanning a white paper, detecting RGB values that represent a minimum white level, and calibrating the data values in a one-dimensional lookup table that exceed the minimum values that represent white.

FIG. 1A illustrates a three-dimensional (3D) lookup table after one-dimensional white calibration. FIG. 1B illustrates an output result of R, G, B, black (K), cyan (C), magenta (M), and yellow (Y) standard colors after the calibration technique illustrated in FIG. 1A has been applied, and FIG. 1C represents the data of FIG. 1B in a line graph. Referring to FIG. 1C, scanning that omits white calibration of the lookup table results in deviations from the desired color in accordance with the data in the lookup table. Therefore, problems in color representation related to the characteristic of a scanning apparatus are not solved, and a white region is represented in color.

Referring to FIGS. 1A to 1C, a conventional white calibration increases the saturation over the input image, and therefore the output image is brighter in tone. This causes a decrease in image contrast, particularly when light colors are used.

FIGS. 1D and 1E illustrate the problems of the conventional white calibration method, in which FIG. 1D shows the result of scanning without white calibration, and FIG. 1E shows the result of scanning with the conventional white calibration. The hue, saturation, value, and lightness may be tabulated as shown below.

Table 1 lists values of specific color regions 10, 20 and 30 of FIG. 1D, and Table 2 lists values of specific color regions 10, 20 and 30 of FIG. 1E.

TABLE 1

| | First region | Second region | Third region |
|---|---|---|---|
| Hue | 308 | 9 | 55 |
| Saturation | 18 | 85 | 18 |
| Value | 98 | 75 | 99 |
| Lightness | 87 | 45 | 97 |

TABLE 2

| | First region | Second region | Third region |
|---|---|---|---|
| Hue | 279 | 10 | 67 |
| Saturation | 9 | 85 | 7 |
| Value | 100 | 81 | 100 |
| Lightness | 94 | 48 | 99 |

Referring to Tables 1 and 2, the overall output image is brightened due to the increase of saturation. The above tables also indicate that the colors with higher lightness have lower reproducibility. That is, the first and third color regions 10 and 30 have lower color reproduction than that of the second color region 20. Accordingly, a scanning apparatus is required, which is capable of conducting white calibration without compromising color representation.

### SUMMARY OF THE INVENTION

The present general inventive concept provides a scanning apparatus to subdivide a multidimensional lookup table into a plurality of data blocks, and to conduct white calibration in a block region that contains a minimum input signal value and a white point, and a white calibration method thereof.

The present general inventive concept also provides a scanning apparatus to provide improved color representation by conducting color calibration according to color regions of a minimum block region which is determined to be a region for the calibration.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a scanning apparatus including a lookup table generating unit to generate a multidimensional lookup table to convert input signals into standard signals, a minimum value computing unit to scan a white reference and compute minimum RGB values from the scanned reference, a calibration region determining unit to establish a minimum size region in the lookup table that contains a background (BG) point where the computed minimum RGB values coincide, and a white point of the 3D lookup table, and a calibrating unit to calibrate data values in only the established region to values corresponding to white values.

If a difference between the minimum RGB values is smaller than a reference value, the calibration region determining unit may establish the minimum size region from regions that include a gray axis of the lookup table as a diagonal line.

The detected region may be a cubic block.

If a difference between the minimum RGB values is equal to or greater than a reference value, the calibration region determining unit may establish the minimum size region to extend into the color region that has the lowest minimum value more than the calibration region extends into other color regions.

The established region may be a cuboidal block that has the white point as a vertex, and that contains the BG point therein.

The lookup table may be a three-dimensional (3D) lookup table and may include (2ⁿ+1)×(2ⁿ+1)×(2ⁿ+1) representative color values and (2ⁿ×2ⁿ×2ⁿ) 3D blocks, and the reference value may be expressed by 256/2ⁿ.

The foregoing and/or other aspects and utilities of the present general inventive concept may also be achieved by providing a scanning apparatus, including a storage unit to store a multidimensional lookup table to convert input signals into standard signals, and a central processing unit to receive white reference data and to compute minimum RGB values therefrom, and to establish a minimum size region in the lookup table that contains a background (BG) point where the computed minimum RGB values coincide in the lookup table, and a white point of the 3D lookup table.

The central processing unit may perform a first calibration of each color axis in the established minimum size region based on the white point.

The CPU may perform the first calibration by substituting an (n) point on each color axis corresponding to the BG point, a difference between the (n) point and the computed minimum value, and a reference value, with:

$${Pn}^{′} = Pw * \frac{( c - a )}{c} + Pn * \frac{( c - b )}{c}$$

where, Pn denotes the n point, Pn′ denotes calibrated point (Pn), Pw denotes a white point, ‘a’ denotes a difference between the (n) point and the minimum value, ‘b’ denotes the reference value, ‘c’ denotes the sum of ‘a’ and ‘b’, and ‘n’ is a natural number.

The CPU may calibrate a value exceeding the calibrated (n′) point into a white value.

The CPU may calibrate a (n+1) point, which is smaller than the (n) point by the reference value, using:

$${P ( n + 1 )}^{′} = \frac{{Pn}^{′} + P ( n + 1 )}{2}$$

where, P(n+1) denotes the (n+1) point, and P(n+1)′ denotes a calibrated P(n+1).

The CPU may perform a second calibration after the first calibration, based on the ratio of color distribution with reference to the respective color axes, in the established minimum size region.

The CPU may perform the second calibration by substituting the calibration point, and the ratio of color distribution with the following equations:

Weight_{—}Ri=(Pi′)/255,

Weight_{—}Gi=(Pi′)/255,

Weight_{—}Bi=(Pi′)/255,

Composite_{—}Ri=Ri*Weight_{—}Gi*Weight_{—}Bi,

Composite_{—}Gi=Gi*Weight_{—}Ri*Weight_{—}Bi,

Composite_{—}Bi=Bi*Weight_{—}Ri*Weight_{—}Gi (where, i={n,n+1}),

where, Weight_Ri denotes ratio of R color distribution of the calibrated Pn′ and P(n+1)′,

Weight_Gi denotes ratio of G color distribution of the calibrated Pn′ and P(n+1)′, and

Weight_Bi denotes ratio of B color distribution of the calibrated Pn′ and P(n+1)′, where

Ri denotes the (n) point on the R axis, Gi denotes the (n) point on the G axis, and Bi denotes the (n) point on the B axis,

Composite_Ri denotes a calibrated internal point obtained based on the ratio of the color distribution on the R axis,

Composite_Gi denotes a calibrated internal point obtained based on the ratio of the color distribution on the G axis, and

Composite_Bi denotes a calibrated internal point obtained based on the ratio of the color distribution on the B axis.

The foregoing and/or other aspects and utilities of the present general inventive concept may also be achieved by providing a method of white calibration, including generating a multidimensional lookup table to convert input signals into standard signals, scanning a white reference and computing minimum RGB values therefrom, determining a minimum size region in the lookup table that contains a background (BG) point where the computed minimum RGB values coincide, and a white point of the lookup table, and calibrating data values only in the determined region to white values.

If a difference between the minimum RGB values is smaller than a reference value, the determining of the minimum size region may include determining the minimum size region from regions in the lookup table that have a gray axis thereof as a diagonal line.

The determining of the minimum size region from regions in the lookup table that have a gray axis may determine the region to be a cubic block.

If a difference between the minimum RGB values is equal to or greater than a reference value, the determining of the minimum size region may include determining the minimum size region to extend into a color region of the lookup table that has the lowest minimum value more than into other color regions in the lookup table.

The determining of the minimum size region to extend into the color region may include determining the minimum size region to be a cuboidal block that has the white point as a vertex, and that contains the BG point therein.

The generating of the lookup table may include generating a three-dimensional (3D) lookup table to include (2ⁿ+1)×(2ⁿ+1)×(2ⁿ+1) representative color values and (2ⁿ×2ⁿ×2ⁿ) 3D blocks, and wherein the reference value is expressed by 256/2ⁿ. The calibrating may include performing a first calibration of each color axis in the established minimum size region based on the white point.

The calibrating may include performing the first calibration by substituting an (n) point on each color axis corresponding to the BG point, a difference between the (n) point and the computed minimum value, and a reference value, with:

$${Pn}^{′} = Pw * \frac{( c - a )}{c} + Pn * \frac{( c - b )}{c}$$

where, Pn denotes the n point, Pn′ denotes calibrated point (Pn), Pw denotes a white point, ‘a’ denotes a difference between the (n) point and the minimum value, ‘b’ denotes the reference value, ‘c’ denotes the sum of ‘a’ and ‘b’, and ‘n’ is a natural number.

The calibrating may include calibrating a value exceeding the calibrated (n′) point into a white value.

The calibrating may include calibrating a (n+1) point, which is smaller than the (n) point by the reference value, using:

$${P ( n + 1 )}^{′} = \frac{{Pn}^{′} + P ( n + 1 )}{2}$$

where, P(n+1) denotes the (n+1) point, and P(n+1)′ denotes a calibrated P(n+1).

The calibrating may further include performing a second calibration after the first calibration, based on the ratio of color distribution with reference to the respective color axes, in the established minimum size region.

The calibrating may include performing the second calibration by substituting the calibration point, and the ratio of color distribution with the following equations:

Weight_{—}Ri=(Pi′)/255,

Weight_{—}Gi=(Pi′)/255,

Weight_{—}Bi=(Pi′)/255,

Composite_{—}Ri=Ri*Weight_{—}Gi*Weight_{—}Bi,

Composite_{—}Gi=Gi*Weight_{—}Ri*Weight_{—}Bi,

Composite_{—}Bi=Bi*Weight_{—}Ri*Weight_{—}Gi (where, i={n,n+1}),

where, Weight_Ri denotes ratio of R color distribution of the calibrated Pn′ and P(n+1)′,

Weight_Gi denotes ratio of G color distribution of the calibrated Pn′ and P(n+1)′, and

Weight_Bi denotes ratio of B color distribution of the calibrated Pn′ and P(n+1)′, where

Ri denotes the (n) point on the R axis, Gi denotes the (n) point on the G axis, and Bi denotes the (n) point on the B axis,

Composite_Ri denotes a calibrated internal point obtained based on the ratio of the color distribution on the R axis,

Composite_Gi denotes a calibrated internal point obtained based on the ratio of the color distribution on the G axis, and

Composite_Bi denotes a calibrated internal point obtained based on the ratio of the color distribution on the B axis.

The foregoing and/or other aspects and utilities of the present general inventive concept may also be achieved by providing a scanning apparatus including a storage unit to store multidimensional lookup table to convert input signals into standard signals, and a central processing unit to receive white reference data and to compute minimum RGB values therefrom, and to establish a minimum size region in the lookup table that contains a background (BG) point where the computed minimum RGB values coincide, and a white point of the lookup table.

The foregoing and/or other aspects and utilities of the present general inventive concept may be achieved by providing a method of white calibration of a scanning apparatus including generating a multidimensional lookup table having respective indexed color components on dimensions thereof defining a color space, populating the lookup table with standardized values of the indexed color components addressed thereat, establishing a white calibration region in the lookup table in accordance with a distribution of the standardized values of colors obtained from a scanned white reference, and modifying the standardized values of the indexed color components in only the established white calibration region of the lookup table to the indexed color components corresponding to the standardized values of white.

The foregoing and/or other aspects and utilities of the present general inventive concept may be achieved by providing a computer readable medium having encoded thereon processor instructions that, when executed by a processor, perform the foregoing method.

The foregoing and/or other aspects and utilities of the present general inventive concept may be achieved by providing a scanning apparatus including a lookup table generating unit to generate a multidimensional lookup table populated with standardized values at addresses thereof corresponding to indexed color components of a color space having like dimensions as the lookup table, a calibration region determining unit to establish a white calibration region in the lookup table in accordance with a distribution of the standardized values of colors obtained from a scanned white reference, and a calibrating unit to calibrate the standardized values of the indexed color components in only the established white calibration region of the lookup table to the indexed color components corresponding to the standardized values of white.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIGS. 1A to 1E are views provided to explain a conventional method of white calibration;

FIG. 2 is a block diagram of a scanning apparatus according to an exemplary embodiment of the present general inventive concept;

FIGS. 3 and 4 are views to explain a method of determining a white calibration region in a 3D lookup table according to an exemplary embodiment of the present general inventive concept;

FIG. 5A is a graphical representation of color levels as white-calibrated according to an exemplary embodiment of the present general inventive concept;

FIG. 5B illustrates a resultant image output after the white calibration according to an exemplary embodiment of the present general inventive concept;

FIG. 6 is a view provided to explain a method of white calibration according to another exemplary embodiment of the present general inventive concept;

FIG. 7 is a block diagram of a scanning apparatus according to another exemplary embodiment of the present general inventive concept;

FIG. 8 illustrates an output image obtained after a white calibration method according to another exemplary embodiment of the present general inventive concept;

FIG. 9 is a flowchart to explain a white calibration method of a scanning apparatus according to an exemplary embodiment of the present general inventive concept; and

FIG. 10 is a flowchart to explain a white calibration method of a scanning apparatus according to another exemplary embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

FIG. 2 is a block diagram of a certain functional components of a scanning apparatus according to an exemplary embodiment of the present general inventive concept.

Referring to FIG. 2, an exemplary scanning apparatus 200 includes a lookup table generating unit 210, a minimum value computing unit 220, a calibration region determining unit 230, and a calibrating unit 240. It is to be understood that scanning apparatus 200 may include functional components other than those illustrated, where such other components have been omitted for clarity in the illustration and in the description thereof.

The exemplary lookup table generating unit 210 generates a multidimensional lookup table (LUT) that includes data structures defining a plurality of blocks, and is used to convert input signals into standard signals. For purposes of explanation, and not limitation, the exemplary lookup table described herein is a three-dimensional (3D) lookup table having indices corresponding to red, green, and blue (RGB) values. The indices may combine to provide an address in memory at which the corresponding standard color data of the color space is stored in the LUT. For example, a logical address in the LUT may contain 8 bits assigned to a red index, 8 bits assigned to a green index, and 8 bits assigned to a blue index, and the bits may form a basis for the logical address in the LUT of the color having a corrected level of red corresponding to the red index, a corrected level of green corresponding to the green index, and a corrected level of blue corresponding to the blue index. Lookup tables of other dimensions corresponding to axes of a color space other than the exemplary RGB color space described herein, as well as alternative absolute or logical addressing schemes in the lookup table, may be used with the present general inventive concept without departing from the spirit and intended scope thereof. Further, it is to be understood that while the lookup table is described in terms of a spatially dimensioned structure of a 3D LUT and 3D blocks, such description is for purposes of explanation, and is not intended to imply physical structure in embodiments of the present general inventive concept. The dimensions referred to are those defining a color space, which have corresponding addresses in the LUT by a suitable addressing scheme to be accessed through a plurality of indices corresponding to each dimension of the color space.

The lookup table generating unit 210 may print out a test color chart of colors from which to generate a lookup table, and may measure a color metric of the colors in the printout of the color chart using, for example, a spectrophotometer and a calorimeter. The lookup table generating unit 210 may then construct the LUT in compliance with standard colors, for example, with the International Color Consortium (ICC) standards, using the color signals obtained by the scanning apparatus 200 and the color metrics measured by the above measuring devices. The resulting LUT contains a mapping from scanned RGB signals to corresponding RGB colors defined by standards in accordance with the measured color metrics.

The lookup table may store, for example, (2ⁿ+1)×(2ⁿ+1)×(2ⁿ+1) representative values (n is a natural number). For example, a (9×9×9) lookup table has 729 representative values, and may have digital values of 0, 32, 64, 96, 128, 160, 192, 224, and 256 as indices of each color axis. A (17×17×17) lookup table has 4913 representative values, and may have 0, 16, 32, 48, 64, 80, 96, 112, 128, 144, 160, 176, 192, 208, 224, 240, and 256 as digital index values defined on each color axis.

A 3D lookup table may be subdivided into a plurality of blocks defined by eight neighboring representative values as the vertices. A (2ⁿ+1)×(2ⁿ+1)×(2ⁿ+1) lookup table may be subdivided into (2ⁿ×2ⁿ×2ⁿ) 3D blocks, and each unit block may be of size (256/2ⁿ×256/2ⁿ×256/2ⁿ) colors.

The exemplary minimum value computing unit 220 receives scan data of a white reference plane, such as a sheet of white paper, and computes minimum R, G, and B values, respectively, from among the scanned white reference data. The scanned RGB values are converted into the standard RGB signals from the input signals based on the 3D lookup table generated by the lookup table generating unit 210.

In certain embodiments of the present general inventive concept, the minimum value computing unit 220 detects a distribution of the output RGB signals, and determines the minimum RGB values, respectively, over the entire distribution.

The exemplary calibration region determining unit 230 determines a minimum size block region that contains the white point (255, 255, 255) and the background (BG) point, i.e., where the minimum RGB values coincide in the color space.

The calibration region may be determined according to a magnitude distribution of the minimum RGB values. If the distribution of the minimum RGB values lies within a reference value, a symmetrical block region is established based on the determination that the minimum RGB values exist near the gray axis.

The gray axis is defined by a line in the RGB color space passing through RGB points having equivalent values of R, G, and B.

If the distribution of the minimum RGB values exceeds the reference value, it can be determined that the lowest of the minimum RGB values is represented on the white region due to characteristics of a certain color sensor. Accordingly, the calibration region determining unit 230 establishes an asymmetrical block region aligned on a color axis that has the lowest minimum value.

In certain embodiments of the present general inventive concept, a (2ⁿ+1)×(2ⁿ+1)×(2ⁿ+1) lookup table has a reference value that can be expressed by 256/2ⁿ.

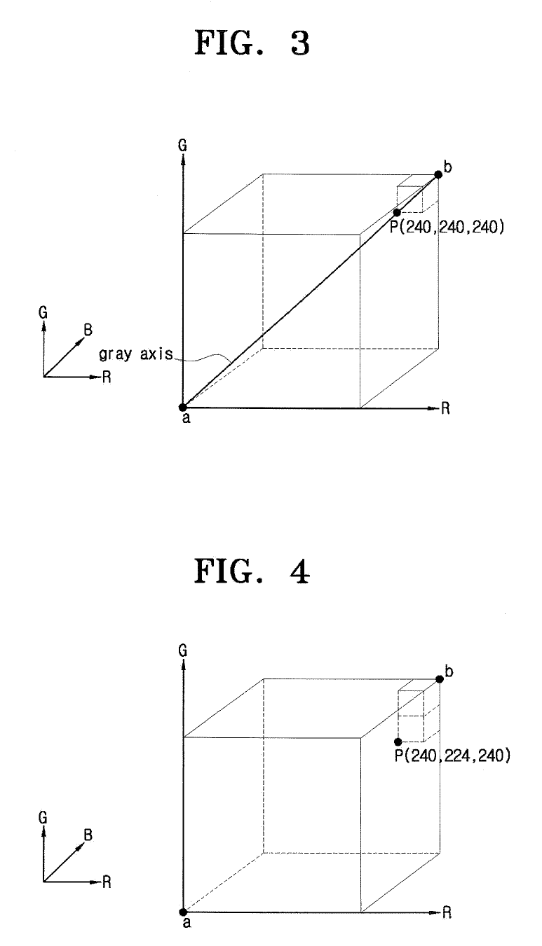

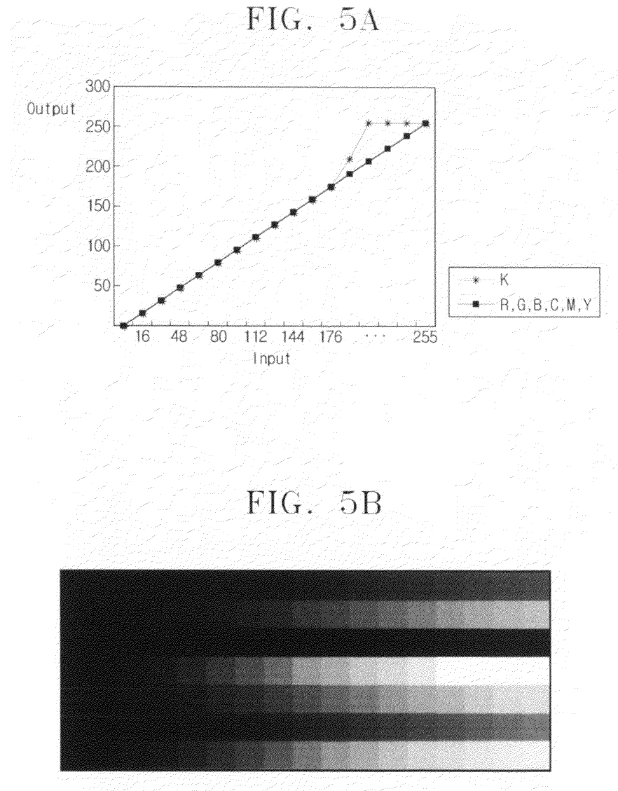

An exemplary method of operation of the calibration region determining unit 230 will be explained below in greater detail with reference to FIGS. 3 and 4.

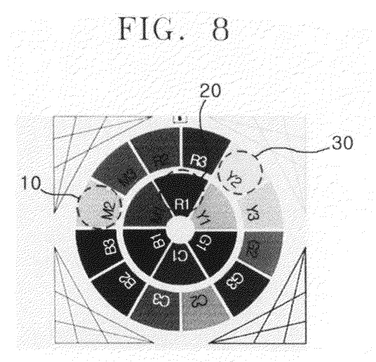

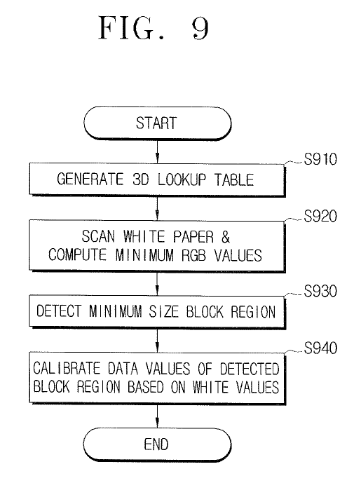

It is to be understood that the exemplary system illustrated in FIG. 2 may be implemented in hardware, software, or a combination of both. For example, certain components, such as the lookup table generating unit 210, the minimum value computing unit 220, the calibration region determining unit 230, and the calibrating unit 240, may be suited to be realized as processor instructions executing in one or more computer execution threads on one or more processors. Each of those functional components may be implemented on a dedicated processor, or may be executed on a single processor, such as the central processing unit 320 of FIG. 7 described below. Alternatively, each component illustrated in FIG. 2 may be realized in one or more application specific circuits. The present general inventive concept may be embodied through numerous configurations other than that illustrated in FIG. 2 without deviating from the spirit and intended scope thereof.

FIGS. 3 and 4 are views provided to explain a method of determining white calibration region using a 3D lookup table according to an exemplary embodiment of the present general inventive concept. FIG. 3 illustrates a method of establishing a symmetrical block region, and FIG. 4 illustrates a method of establishing an asymmetrical block region. A (17×17×17) 3D lookup table will used as an example.

Referring to FIG. 3, exemplary minimum RGB values of 245, 244, and 242 are computed at the minimum value computing unit 220, and a maximum difference between these minimum values is 3, which is less than a reference value of, for example, 256/2ⁿ, which is 16 for n=4. Accordingly, a symmetrical block region is established along the gray axis.

The symmetrical block region has a gray axis defined by a diagonal line that connects a white point with one vertex of a unit block that contains a BG point at the coordinates of the minimum RGB values. A minimum size symmetrical block region containing the BG point is established as a target region of calibration, and a vertex (P) of a block on the gray axis opposite the white point has RGB values of (240, 240, 240). As a result, a cubic block region is established.

Referring to FIG. 4, the exemplary minimum RGB values of 245, 226, and 242 are computed from the minimum value computing unit 220, and the maximum difference between the minimum values is 19, which exceeds the reference value of 16.

Accordingly, an asymmetrical block region is established having a major axis parallel with the G color axis, which is the color that has the lowest minimum value among the minimum RGB values. That is, the asymmetrical block region forms a cuboidal block whose diagonal line connects the white point with point (P) having RGB values (240, 224, 240). The point (P) refers to a vertex of a unit block that contains the minimum RGB values, and the asymmetrical block region is thus defined by two unit blocks. The asymmetrical block region thus extends into the green color region more than it extends into the other color regions.

The exemplary calibrating unit 240 calibrates data values in the block region established by the calibration region determining unit 230 to standard white values. Accordingly, a 3D lookup table is calibrated, as the data values in the established block region are converted into a color corresponding to RGB triplet (255, 255, 255).

FIG. 5A is a graphical representation of output values after white calibration according to an exemplary embodiment of the present general inventive concept. That is, FIG. 5A represents output color values after scanning using a 3D lookup table calibrated in the symmetrical block region of FIG. 3. According to FIG. 5A, output value K is changed without influencing other color regions.

FIG. 5B illustrates an image output after white calibration according to an exemplary embodiment of the present general inventive concept. That is, FIG. 5B illustrates an output image after a color patch having input values of FIG. 5A is scanned and reconstructed based on the output values in the calibrated 3D lookup table. Referring to FIG. 5B, a white region is calibrated, without influencing other color regions.

Meanwhile, the exemplary calibration unit 240 may perform a more detailed level of calibration based on the ratio of RGB color distributions, by detecting only the white region from the minimum size block region detected by the calibration region determining unit 230.

Specifically, the exemplary calibration unit 240 performs the first calibration along the RGB axes on the 3D lookup table, and then performs the second calibration with the interior of the minimum size block region detected by the calibration region determining unit 230.

More specifically, the exemplary calibration unit 240 performs the first calibration, using a minimum RGB computed by the minimum value computing unit 220, a difference between the minimum RGB and the point on the RGB axes that corresponds to the BG point (RPn, GPn, BPn) of the block region containing the minimum RGB, and the RGB axis point corresponding to the BG point (P) and the point which is smaller than the BG point (P) by the reference value. Meanwhile, the RGB axis point corresponding to the BG point (P) may be calibrated by the following mathematical expression:

$${Pn}^{′} = Pw * \frac{( c - a )}{c} + Pn * \frac{( c - b )}{c} , \qquad [ Mathematical expression 1 ]$$

where, Pn denotes RGB axis point corresponding to the BG point (P), Pn′ denotes calibrated point (Pn), Pw denotes a white point, ‘a’ denotes a difference between the Pn point and the minimum value, and ‘b’ denotes reference value. The white point may be 255, and n is a natural number.

The point smaller than Pn by the reference value may be calibrated by the following mathematical expression:

$${P ( n + 1 )}^{′} = \frac{{Pn}^{′} + P ( n + 1 )}{2} , \qquad [ Mathematical expression 2 ]$$

where, P(n+1) denotes a point smaller than Pn by a reference value, and P(n+1)′ denotes a calibrated point P(n+1).

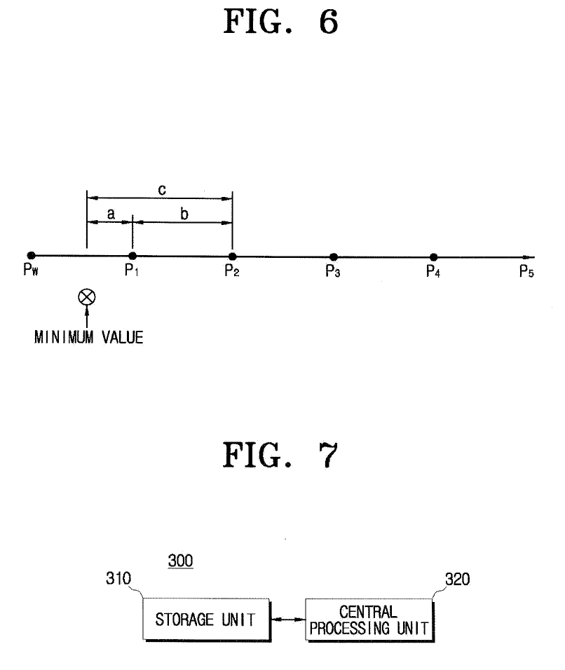

An example embodiment of the present general inventive concept will be explained below with reference to mathematical expressions 1 and 2 and FIG. 6.

FIG. 6 is a view provided to explain a white calibration method according to an example embodiment of the present general inventive concept.

FIG. 6 may represent RGB axes on the 3D lookup table, in which the coordinates of the representative color values are aligned in a sequence of the white point (Pw), the first point (P1), second point (P2), . . . , and (m)th point (Pm). Take an example of (17×17×17) 3D lookup table, since the interval between the points, that is, the reference value is 16, and the first point (P1) is 240, the second point (P2) is 224, and so on, and the sixteenth point (P16) is zero (0).

An example scanning apparatus having the minimum RGB of (245, 240, 228) and a (17×17×17) 3D lookup table, will be explained below.

In this example, the BG points (RPn, GPn, BPn) are (240, 240, 224). Accordingly, RPn corresponds to the P1, that is, 240. Further, P(n+1) is the P2, that is, 224. The RPn coordinates on the 3D lookup table may be (240, 255, 255).

In this example, ‘a’ may be 5, ‘b’ may be 16, and ‘c’ may be 21. A calibration along the R axis may thus be performed, by incorporating these values into mathematical expressions 1 and 2.

The calibrated P1, that is, P1′=251, is obtained from mathematical expression 1. Further, the calibrated P2, that is, P2′=237, is obtained from mathematical expression 2. Since value 251 or above along the R axis is calibrated with the white value 255, the color values existing between the calibrated P2 and P1 range from 251 to 237.

The color values between the calibrated P2 and P1 have a color distribution based on the linear interpolation of mathematical expression 2. While mathematical expression 2 is applied regarding the calibrated P(n+1), that is, P(n+1)′ based on the linear interpolation, other calibration method such as gamma correction is also applicable.

The same calibration method is applied to G and B axes. Since the rapid change of brightness is decreased in the respective points, problems such as a tone jumping, in which reproduction curves are generated in an image, can be avoided.

The exemplary calibration unit 240 may perform the second calibration in a more detailed level, by applying weights according to the ratio of color distributions to the points existing in the minimum size block region detected by the calibration region determining unit 230, with reference to the RGB axes calibrated with mathematical expressions 1 and 2. This second calibration is called herein an ‘internal point calibration.’

The internal point calibration may be computed by the following:

Weight_{—}Ri=(Pi′)/255,

Weight_{—}Gi=(Pi′)/255,

Weight_{—}Bi=(Pi′)/255,

Composite_{—}Ri=Ri*Weight_{—}Gi*Weight_{—}Bi,

Composite_{—}Gi=Gi*Weight_{—}Ri*Weight_{—}Bi,

Composite_{—}Bi=Bi*Weight_{—}Ri*Weight_{—}Gi (where, i={n,n+1}), [Mathematical expression 3]

where, Weight_Ri denotes ratio of R color distribution of the calibrated Pn′ and P(n+1)′, Weight_Gi denotes ratio of G color distribution of the calibrated Pn′ and P(n+1)′, and Weight_Bi denotes ratio of B color distribution of the calibrated Pn′ and P(n+1)′. Composite_Ri denotes a calibrated internal point obtained by applying weights based on the ratios of the RGB color distributions.

Pi′ denotes a calibration point of the Pi obtained by using mathematical expressions 1 and 2. Ri denotes Pi of the R axis, Gi denotes Pi of the G axis, and Bi denotes Pi of the B axis. Pi denotes the (n)th point and the (n+1)th point, which correspond to the Pn of mathematical expression 1 and the P(n+1) of mathematical expression 2.

Although the point calibration regarding the representative color values have been explained as an example, one will understand that such calibration is equally applicable to other types of points among the representative color values. Accordingly, the white calibration is performed for each of the colors in a more detailed level, so that the changes in color, saturation and brightness are minimized and color representation is improved.

FIG. 7 is a block diagram of a scanning apparatus according to an exemplary embodiment of the present general inventive concept.

Referring to FIG. 7, the scanning apparatus 300 includes a storage unit 310, a central processing unit 320, and a scanner 330 (not illustrated). The exemplary storage unit 310 stores, among other things, a 3D lookup table to convert input signals from the scanner 330 into standard signals. The lookup table may have (2ⁿ+1)×(2ⁿ+1)×(2ⁿ+1) representative color values (n is a natural number), as described above.

The 3D lookup table may be subdivided into a plurality of blocks each defined by eight neighboring representative values as the vertices. Accordingly, a (2ⁿ+1)×(2ⁿ+1)×(2ⁿ+1) lookup table may be subdivided into (2ⁿ×2ⁿ×2ⁿ) 3D blocks, each of which has a size of 256/2ⁿ×256/2ⁿ×256/2ⁿ colors.

The exemplary scanner 330 scans a white reference, and the central processing unit 320 computes minimum RGB values of the standard colors in the LUT corresponding to the scanned white data, detects a minimum size region that contains a white point and a background (BG) point where the computed minimum RGB values coincide in the color space, and conducts a white calibration process accordingly. The exemplary CPU 320 may be implemented to operate as the minimum value computing unit 220, the calibration region determining unit 230, and the calibrating unit 240 of FIG. 2.

The exemplary CPU 320 conducts a first calibration, starting from the white point and going along the respective color axes, in the minimum size block region. After the first calibration, the exemplary CPU 320 conducts a second calibration along the respective color axes according to the ratios of the color distributions, in the minimum size block region. The first calibration may involve mathematical expressions 1 and 2, and the second calibration may involve mathematical expression 3.

According to the calibrations at the exemplary CPU 320, the exemplary storage unit 310 stores a 3D lookup table incorporating the result of white calibration. Accordingly, the exemplary storage unit 310 stores a 3D lookup table which differently applies the white calibration regions according to the ratios of the color distributions. The white calibration regions of the 3D lookup table may desirably have a dynamic calibration pattern, rather than a fixed pattern.

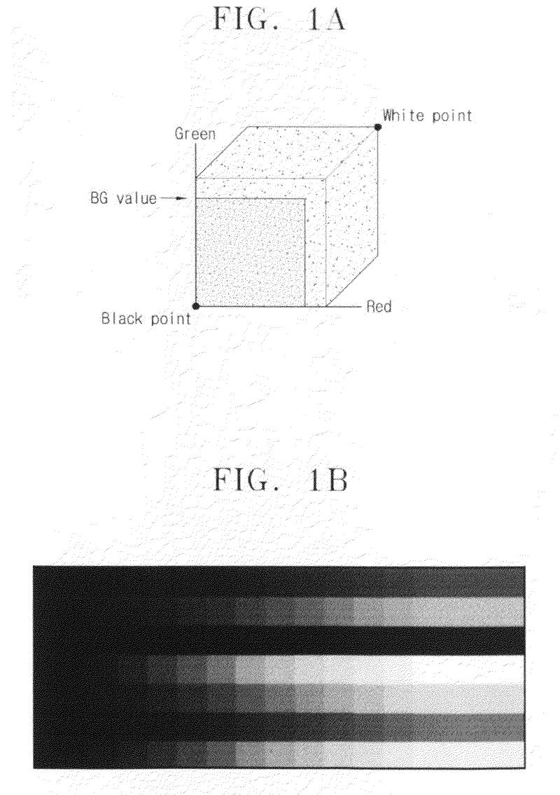

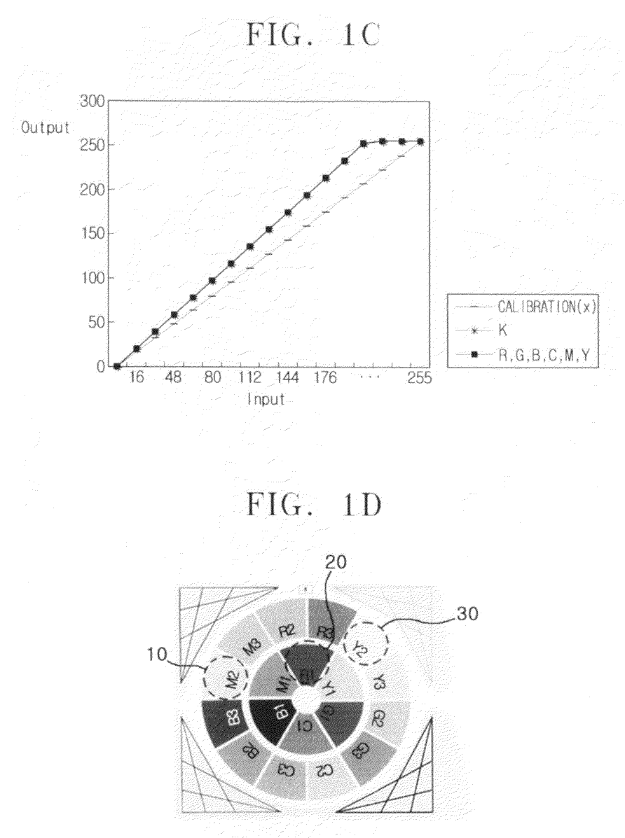

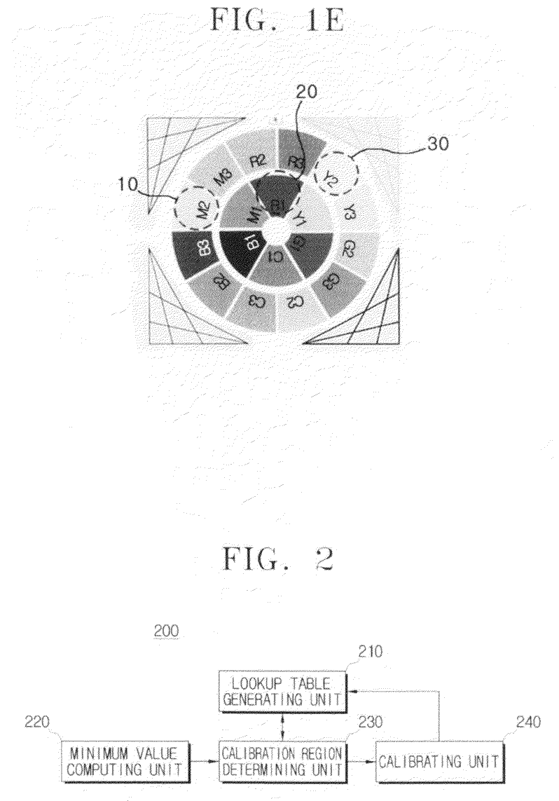

FIG. 8 illustrates a result of white calibration conducted according to mathematical expressions 1 to 3. If the color chart is scanned under the same conditions as those in FIGS. 1D and 1E, the result of white calibration can be tabulated as follows:

TABLE 3

| | First region | Second region | Third region |
|---|---|---|---|
| Hue | 308 | 9 | 57 |
| Saturation | 18 | 85 | 17 |
| Value | 98 | 75 | 99 |
| Lightness | 87 | 45 | 98 |

Compared to Tables 1 and 2, Table 3 has an enhanced level of hue, notwithstanding the white calibration.

FIG. 9 is a flowchart to explain a white calibration method of a scanning apparatus according to an exemplary embodiment of the present general inventive concept.

Referring to FIG. 9, a 3D lookup table is generated at operation S910, including a plurality of 3D blocks and to be used to convert input signals into standard signals. The 3D lookup table may be generated by measuring light intensity of a test color chart using appropriate measuring devices, and by using a color signal of the scanning apparatus 200 and the measured result of the measuring devices. The 3D lookup table generated may have the size of (2ⁿ+1)×(2ⁿ+1)×(2ⁿ+1) representative values.

At operation S920, a white reference is scanned and minimum RGB values are computed to establish a white calibration region.

In particular, a white reference is scanned, a distribution of output RGB signals is detected, and minimum RGB values are determined. The scanned RGB values are the standard RGB signals that are converted from input signals according to the 3D lookup table.

At operation S930, a minimum size block region is determined that contains a background (BG) point where the minimum RGB values coincide, and a white point.

The calibration region may be determined according to the magnitude distribution of the minimum RGB values. If the distribution of the minimum RGB values exists within a reference value, a symmetrical block region is established based on the determination that the minimum RGB values exist near a gray axis. The gray axis includes like representative values of R, G and B.

If the distribution of the minimum RGB values exceeds the reference value, it can be determined that the lowest of the minimum RGB values is represented in the white region due to characteristics of certain color sensor. Accordingly, an asymmetrical block region is established in a direction of the color region that has the lowest minimum color value. The reference value may be 256/2ⁿ.

At operation S940, data values of the established block region are calibrated to standard white values. Accordingly, only a white calibration region is established and calibrated, without influencing other color regions.

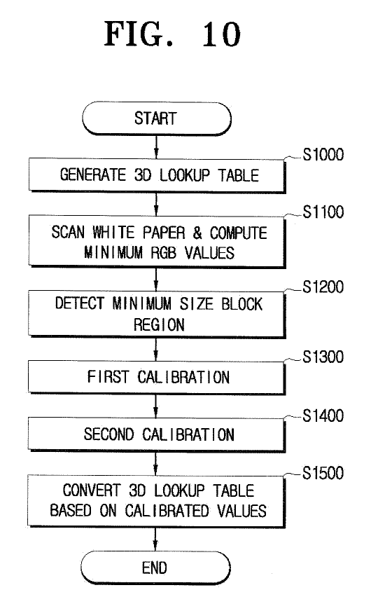

Meanwhile, FIG. 10 illustrates a flowchart to explain a white calibration method according to another exemplary embodiment of the present general inventive concept.

Referring to FIG. 10, a 3D lookup table is generated at operation S1000, including a plurality of 3D blocks and to be used to convert input signals into standard signals. Since the manner of generating the 3D lookup table is already explained above with reference to FIG. 9, this will not be explained below for the sake of brevity.

At operation S1100, a white reference is scanned and minimum RGB values are computed to establish a white calibration region.

At operation S1200, a minimum size block region is determined that contains a background (BG) point where the minimum RGB values coincide, and a white point. The minimum size block region may be a symmetric or asymmetric block region containing at least one unit block. A vertex in a diagonal relation with respect to the white point of the detected minimum size block region may be established as a BG point.

A white calibration may then be conducted, while improving a color representation, by calibrating the representative color values corresponding to the points contained in the detected minimum size block region. At operation S1300, the first calibration is conducted along the RGB axes of the 3D lookup table, and at operation S1400, the second calibration is conducted regarding the interior of the minimum size block region.

More specifically, the first calibration may be conducted, using minimum R, G, B, differences between the minimum R, G, B and the points on the RGB axes that correspond to the BG point (RPn, GPn, BPn) of the block region containing the minimum RGB, and the RGB axis point corresponding to the BG point (P) and the point which is smaller than the BG point (P) by the reference value.

The RGB axis points corresponding to the BG points (P) may be calibrated by above mathematical expression 1. Points exceeding the calibrated point are calibrated to the white value.

The points smaller than Pn by the reference values may be calibrated by above mathematical expression 2. Since the rapid change of brightness is decreased in the respective points, problems such as a tone jumping, in which reproduction curves are generated in an image, can be avoided.

The second calibration may be conducted in a more detailed level, by applying weights according to the ratio of color distributions to the points existing in the minimum size block region, with reference to the RGB axes calibrated with mathematical expressions 1 and 2. The interior points may be calibrated using above mathematical expression 3. Accordingly, the white calibration is performed for each of the colors in a more detailed level, so that the changes in color, saturation and brightness are minimized and color representation is improved.

At operation S1500, the 3D lookup table is converted by applying the calibrated values.

As explained above, a 3D lookup table is subdivided into a plurality of blocks, and white calibration is carried out in a block region that contains a minimum input signal and a white point. As a result, optimum color representation is provided.

Furthermore, since the changes in brightness are calibrated linearly along the respective color axes, problems such as tone jumping can be avoided.

Furthermore, since different white calibration regions are applied for each of the colors, a more detailed level of calibration is provided.

Furthermore, since only a white region is detected and calibrated, without influencing the other color regions, optimum color representation is provided.

Certain embodiments of the present general inventive concept provide for the functional components to manufactured, transported, marketed and/or sold as processor instructions encoded on computer-readable media. The present general inventive concept, when so embodied, can be practiced regardless of the processing platform on which the processor instructions are executed and regardless of the manner by which the processor instructions are encoded on the medium.

It is to be understood that the computer-readable medium may be any medium on which the instructions may be encoded and then subsequently retrieved, decoded and executed by a processor, including electrical, magnetic and optical storage devices, and wired, wireless, optical and acoustical communication channels. The computer readable medium may include either or both of persistent storage, referred to herein as “computer-readable recording media” and as spatiotemporal storage, referred to herein as “computer-readable transmission media”. Examples of computer-readable recording media include, but not limited to, read-only memory (ROM), random-access memory (RAM), and other electrical storage; CD-ROM, DVD, and other optical storage; and magnetic tape, floppy disks, hard disks and other magnetic storage. The computer-readable recording media may be distributed across components, to include such distribution through storage systems interconnected through a communication network. The computer-readable transmission media may transmit encoded instructions on electromagnetic carrier waves or signals, or as acoustic signals through acoustically transmissive media. Moreover, the processor instructions may be derived from algorithmic constructions of the present general inventive concept in various programming languages, the mere contemplation of which illustrates the numerous realizable abstractions of the present general inventive concept.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A scanning apparatus, comprising:
a lookup table generating unit to generate a multidimensional lookup table to convert input signals into standard signals;
a minimum value computing unit to scan a white reference and compute minimum RGB values from the scanned reference;
a calibration region determining unit to establish a minimum size region to calibrate in the lookup table that contains a background (BG) point where the computed minimum RGB values coincide and a white point of the lookup table; and
a calibrating unit to calibrate data values in only the established region to values corresponding to white.

2. The scanning apparatus of claim 1, wherein the calibration region determining unit establishes the minimum size region from regions that include a gray axis of the lookup table as a diagonal line if a difference between the minimum RGB values is smaller than a reference value.

3. The scanning apparatus of claim 2, wherein the established region is a cubic block.

4. The scanning apparatus of claim 1, wherein the calibration region determining unit establishes the minimum size region to extend into a color region of the lookup table that has a lowest one of the minimum RGB values more than in other color regions of the lookup table if a difference between the minimum RGB values is equal to or greater than a reference value.

5. The scanning apparatus of claim 4, wherein the established region is a cuboidal block that has the white point as a vertex, and that contains the BG point therein.

6. The scanning apparatus of claim 2, wherein the lookup table is a three dimensional (3D) lookup table and includes (2ⁿ+1)×(2ⁿ+1)×(2ⁿ+1) representative color values in (2ⁿ×2ⁿ×2ⁿ) 3D blocks, and wherein the reference value is expressed by 256/2ⁿ.

7. A scanning apparatus, comprising:
a storage unit to store a multidimensional lookup table to convert input signals into standard signals; and
a central processing unit to receive white reference data and to compute minimum RGB values therefrom, and to establish a minimum size region in the lookup table that contains a background (BG) point where the computed minimum RGB values coincide in the lookup table, and a white point of the 3D lookup table.

8. The scanning apparatus of claim 7, wherein the central processing unit performs a first calibration of each color axis in the established minimum size region based on the white point.

9. The scanning apparatus of claim 8, wherein the CPU performs the first calibration by substituting an (n) point on each color axis corresponding to the BG point, a difference between the (n) point and the computed minimum value, and a reference value, with:
$${Pn}^{′} = Pw * \frac{( c - a )}{c} + Pn * \frac{( c - b )}{c}$$
where, Pn denotes the n point, Pn′ denotes calibrated point (Pn), Pw denotes a white point, ‘a’ denotes a difference between the (n) point and the minimum value, ‘b’ denotes the reference value, ‘c’ denotes the sum of ‘a’ and ‘b’, and ‘n’ is a natural number.

10. The scanning apparatus of claim 9, wherein the CPU calibrates a value exceeding the calibrated (n′) point into a white value.

11. The scanning apparatus of claim 10, wherein the CPU calibrates a (n+1) point, which is smaller than the (n) point by the reference value, using:
$${P ( n + 1 )}^{′} = \frac{{Pn}^{′} + P ( n + 1 )}{2}$$
where, P(n+1) denotes the (n+1) point, and P(n+1)′ denotes a calibrated P(n+1).

12. The scanning apparatus of claim 11, wherein the CPU performs a second calibration after the first calibration, based on the ratio of color distribution with reference to the respective color axes, in the established minimum size region.

13. The scanning apparatus of claim 12, wherein the CPU performs the second calibration by substituting the calibration point, and the ratio of color distribution with the following equations:
Weight_{—}Ri=(Pi′)/255,
Weight_{—}Gi=(Pi′)/255,
Weight_{—}Bi=(Pi′)/255,
Composite_{—}Ri=Ri*Weight_{—}Gi*Weight_{—}Bi,
Composite_{—}Gi=Gi*Weight_{—}Ri*Weight_{—}Bi,
Composite_{—}Bi=Bi*Weight_{—}Ri*Weight_{—}Gi (where, i={n,n+1}),
where, Weight_Ri denotes ratio of R color distribution of the calibrated Pn′ and P(n+1)′,
Weight_Gi denotes ratio of G color distribution of the calibrated Pn′ and P(n+1)′, and
Weight_Bi denotes ratio of B color distribution of the calibrated Pn′ and P(n+1)′, where
Ri denotes the (n) point on the R axis, Gi denotes the (n) point on the G axis, and Bi denotes the (n) point on the B axis,
Composite_Ri denotes a calibrated internal point obtained based on the ratio of the color distribution on the R axis,
Composite_Gi denotes a calibrated internal point obtained based on the ratio of the color distribution on the G axis, and
Composite_Bi denotes a calibrated internal point obtained based on the ratio of the color distribution on the B axis.

14. A method of white calibration, comprising:
generating a multidimensional lookup table to convert input signals into standard signals;
scanning a white reference and computing minimum RGB values therefrom;
determining a minimum size region in the lookup table that contains a background (BG) point where the computed minimum RGB values coincide, and a white point of the lookup table; and
calibrating data values in only the determined region to white values.

15. The method of white calibration of claim 14, wherein the determining of the minimum size region comprises:
determining the minimum size region from regions in the lookup table that include a gray axis thereof as a diagonal line if a difference between the minimum RGB values is smaller than a reference value.

16. The method of white calibration of claim 15, wherein the determining the minimum size region from regions in the lookup table that include a gray axis includes determining the region as a cubic block.

17. The method of white calibration of claim 14, wherein the determining of the minimum size region comprises:
determining the minimum size region that extends into a color region of the lookup table that has a lowest minimum value more than into other color regions in the lookup table if a difference between the minimum RGB values is equal to or greater than a reference value.

18. The method of white calibration of claim 17, wherein the determining of the minimum size region that extends into the color region includes determining the region as a cuboidal block that has the white point as a vertex, and that contains the BG point therein.

19. The method of white calibration of claim 15, wherein the generating of the multidimensional lookup table includes generating a three-dimensional (3D) lookup table to include (2ⁿ+1)×(2ⁿ+1)×(2ⁿ+1) representative color values and (2ⁿ×2ⁿ×2ⁿ) 3D blocks, and wherein the reference value is expressed by 256/2ⁿ.

20. The method of claim 14, wherein the calibrating includes performing a first calibration of each color axis in the established minimum size region based on the white point.

21. The method of claim 20, wherein the calibrating includes performing the first calibration by substituting an (n) point on each color axis corresponding to the BG point, a difference between the (n) point and the computed minimum value, and a reference value, with:
$${Pn}^{′} = Pw * \frac{( c - a )}{c} + Pn * \frac{( c - b )}{c}$$
where, Pn denotes the n point, Pn′ denotes calibrated point (Pn), Pw denotes a white point, ‘a’ denotes a difference between the (n) point and the minimum value, ‘b’ denotes the reference value, ‘c’ denotes the sum of ‘a’ and ‘b’, and ‘n’ is a natural number.

22. The method of claim 21, wherein the calibrating includes calibrating a value exceeding the calibrated (n′) point into a white value.

23. The method of claim 22, wherein the calibrating includes calibrating a (n+1) point, which is smaller than the (n) point by the reference value, using:
$${P ( n + 1 )}^{′} = \frac{{Pn}^{′} + P ( n + 1 )}{2}$$
where, P(n+1) denotes the (n+1) point, and P(n+1)′ denotes a calibrated P(n+1).

24. The method of claim 23, wherein the calibrating further includes performing a second calibration after the first calibration, based on the ratio of color distribution with reference to the respective color axes, in the established minimum size region.

25. The method of claim 24, wherein the calibrating includes performing the second calibration by substituting the calibration point, and the ratio of color distribution with the following equations:
Weight_{—}Ri=(Pi′)/255,
Weight_{—}Gi=(Pi′)/255,
Weight_{—}Bi=(Pi′)/255,
Composite_{—}Ri=Ri*Weight_{—}Gi*Weight_{—}Bi,
Composite_{—}Gi=Gi*Weight_{—}Ri*Weight_{—}Bi,
Composite_{—}Bi=Bi*Weight_{—}Ri*Weight_{—}Gi (where, i={n,n+1}),
where, Weight_Ri denotes ratio of R color distribution of the calibrated Pn′ and P(n+1)′,
Weight_Gi denotes ratio of G color distribution of the calibrated Pn′ and P(n+1)′, and
Weight_Bi denotes ratio of B color distribution of the calibrated Pn′ and P(n+1)′, where
Ri denotes the (n) point on the R axis, Gi denotes the (n) point on the G axis, and Bi denotes the (n) point on the B axis,
Composite_Ri denotes a calibrated internal point obtained based on the ratio of the color distribution on the R axis,
Composite_Gi denotes a calibrated internal point obtained based on the ratio of the color distribution on the G axis, and
Composite_Bi denotes a calibrated internal point obtained based on the ratio of the color distribution on the B axis.

26. A method of white calibration of a scanning apparatus comprising:
generating a multidimensional lookup table having respective indexed color components on dimensions thereof defining a color space;
populating the lookup table with standardized values of the indexed color components addressed thereby;
establishing a white calibration region in the lookup table in accordance with a distribution of the standardized values of colors obtained from a scanned white reference; and
modifying the standardized values of the indexed color components in only the established white calibration region of the lookup table to the indexed color components corresponding to the standardized values of white.

27. The method of white calibration of claim 26, wherein the establishing of the white calibration region includes determining whether the distribution of the standardized values of the scanned white reference is within a reference value.

28. The method of white calibration of claim 27, wherein the establishing of the white calibration region includes establishing the white calibration region to symmetrically align on indexed color components corresponding to a gray axis of the color space if the distribution of the standardized values of the scanned white reference is within the reference value.

29. The method of white calibration of claim 27, wherein the establishing of the white calibration region includes establishing the white calibration region to include a greater number of one of the indexed color components therein that most deviates from the distribution of the standardized values of the scanned white reference if the distribution of the standardized values of the scanned white reference is not within the reference value.

30. The method of white calibration of claim 26, wherein the establishing of the white calibration region further comprises:
partitioning the lookup table into blocks of like dimensions as the multidimensional lookup table; and
establishing the white calibration region as an integral number of the blocks.

31. The method of white calibration of claim 30, wherein the partitioning of the lookup table includes establishing the blocks to have respective vertices on neighboring ones of the indexed color components in the lookup table.

32. A computer readable medium having encoded thereon processor instructions that, when executed by a processor performs the method of claim 26.

33. A scanning apparatus comprising:
a lookup table generating unit to generate a multidimensional lookup table populated with standardized values at addresses thereof corresponding to indexed color components of a color space having like dimensions as the lookup table;
a calibration region determining unit to establish a white calibration region in the lookup table in accordance with a distribution of the standardized values of colors obtained from a scanned white reference; and
a calibrating unit to calibrate the standardized values of the indexed color components in only the established white calibration region of the lookup table to the indexed color components corresponding to the standardized values of white.

34. The scanning apparatus of claim 33, wherein the calibration region determining unit determines whether the distribution of the standardized values of the scanned white reference is within a reference value.

35. The scanning apparatus of claim 34, wherein the calibration region determining unit establishes the white calibration region to symmetrically align on indexed color components corresponding to a gray axis of the color space if the distribution of the standardized values of the scanned white reference is within the reference value and to include a greater number of one of the indexed color components therein that most deviates from the distribution of the standardized values of the scanned white reference if the distribution of the standardized values of the scanned white reference is not within the reference value.

36. The scanning apparatus of claim 33 further comprising:
a minimum value computing unit to determine the distribution of the standardized values of the scanned white reference from a distribution of minimum values thereof.

37. The scanning apparatus of claim 33 further comprising:
a scanner to provide signals corresponding to the indexed color components.
